(19) United States
(12) Patent Application Publication
(10) Pub. No.: US 2026/0143057 A1
(43) Pub. Date: May 21, 2026

(54) SYSTEMS AND METHODS FOR PROVIDING REAL-TIME TELECOM IDENTIFICATION AND ANALYTICS WITH THE ESTABLISHMENT OF A UNIFIED COMMON DATA MODEL

(71) Applicant: MT International LLC, Mt. Juliet, TN (US)

(72) Inventors: Amanda PIETROCOLA, Mt. Juliet, TN (US); Jim Riley CALDWELL, JR., Mt. Juliet, TN (US); Jessica Eleanor WESSELMANN, Mt. Juliet, TN (US)

(21) Appl. No.: 19/382,517

(22) Filed: Nov. 7, 2025

Related U.S. Application Data
(60) Provisional application No. 63/722,295, filed on Nov. 19, 2024.

(51) Int. Cl. H04M 1/27457; H04M 3/42

(52) U.S. Cl. CPC H04M 1/27457; H04M 3/42059

(57) ABSTRACT

A method, computer program product, and computer system for receiving, by a first computing device, a request identifying a telecom number from a second computing device. It may be determined that a record associated with the telecom number exists in a datastore and that the record is stale. Data associated with the telecom number may be retrieved from a plurality of heterogeneous data sources. Weights may be assigned to the data based upon, at least in part, a plurality of attributes. A unified record for the telecom number may be generated that conforms to a common data model. The unified record may be provided to the second computing device in response to the request.

### RELATED CASES

This application claims the benefits of U.S. Provisional Application No. 63/722,295 filed on 19 November 2024, which is incorporated by reference herein its entirety.

### BACKGROUND

Today, there is no known reliable way to obtain accurate, real-time information about the identity or ownership of a telecom number. Businesses and consumers must rely on static databases, outdated Caller Name (CNAM) lookups, or expensive data warehouses purchased in bulk. These sources are often incomplete, inconsistent, or already stale by the time they are used. For example, one carrier may return “unknown,” another a business name, and another a personal name for the exact same number, with no unified model. Smaller companies are effectively excluded because there is no affordable “per-lookup” option—only costly bulk database subscriptions. Moreover, none of the existing solutions provide real-time insights, verification scoring, or AI-based categorization. As a result, enterprises, carriers, and end-users are left without a trustworthy or scalable way to verify telecom numbers, protect against fraud, or enrich customer data in real time.

### SUMMARY

In one example implementation, a method, performed by one or more computing devices, may include but is not limited to receiving, by a first computing device, a request identifying a telecom number from a second computing device. It may be determined that a record associated with the telecom number exists in a datastore and that the record is stale. Data associated with the telecom number may be retrieved from a plurality of heterogeneous data sources. Weights may be assigned to the data based upon, at least in part, a plurality of attributes. A unified record for the telecom number may be generated that conforms to a common data model. The unified record may be provided to the second computing device in response to the request.

One or more of the following example features may be included. The request may be received as an authenticated API call including one or more parameters, the one or more parameters including one or more of the telecom number, country code, name, address, keyword, and search depth. The plurality of heterogeneous data sources may include at least one verified partner repository and at least one search-engine results provider. The plurality of attributes may include at least two of whether the data is verified or unverified, ranking position in a search engine, timestamp of a prior validation, and consistency across the plurality of heterogeneous data sources. Assigning the weights may include classifying the data into verified data and unverified data and assigning higher weights to the verified data than to the unverified data. Generating the unified record for the telecom number that conforms to the common data model may include producing fields generated by an artificial-intelligence model in accordance with the weights assigned to the data, the fields including at least one of a title, a category, a description, a keyword, and domain information. At least one rule may be applied to the unified record, the at least one rule may include one or more of blocking a call associated with the telecom number, logging the call associated with the telecom number, updating caller identification information for the telecom number, and updating a customer relationship management database.

In another example implementation, a computing system may include one or more processors and one or more memories configured to perform operations that may include but are not limited to receiving, by a first computing device, a request identifying a telecom number from a second computing device. It may be determined that a record associated with the telecom number exists in a datastore and that the record is stale. Data associated with the telecom number may be retrieved from a plurality of heterogeneous data sources. Weights may be assigned to the data based upon, at least in part, a plurality of attributes. A unified record for the telecom number may be generated that conforms to a common data model. The unified record may be provided to the second computing device in response to the request.

One or more of the following example features may be included. The request may be received as an authenticated API call including one or more parameters, the one or more parameters including one or more of the telecom number, country code, name, address, keyword, and search depth. The plurality of heterogeneous data sources may include at least one verified partner repository and at least one search-engine results provider. The plurality of attributes may include at least two of whether the data is verified or unverified, ranking position in a search engine, timestamp of a prior validation, and consistency across the plurality of heterogeneous data sources. Assigning the weights may include classifying the data into verified data and unverified data and assigning higher weights to the verified data than to the unverified data. Generating the unified record for the telecom number that conforms to the common data model may include producing fields generated by an artificial-intelligence model in accordance with the weights assigned to the data, the fields including at least one of a title, a category, a description, a keyword, and domain information. At least one rule may be applied to the unified record, the at least one rule may include one or more of blocking a call associated with the telecom number, logging the call associated with the telecom number, updating caller identification information for the telecom number, and updating a customer relationship management database.

In another example implementation, a computer program product may reside on a computer readable storage medium having a plurality of instructions stored thereon which, when executed across one or more processors, may cause at least a portion of the one or more processors to perform operations that may include but are not limited to receiving, by a first computing device, a request identifying a telecom number from a second computing device. It may be determined that a record associated with the telecom number exists in a datastore and that the record is stale. Data associated with the telecom number may be retrieved from a plurality of heterogeneous data sources. Weights may be assigned to the data based upon, at least in part, a plurality of attributes. A unified record for the telecom number may be generated that conforms to a common data model. The unified record may be provided to the second computing device in response to the request.

One or more of the following example features may be included. The request may be received as an authenticated API call including one or more parameters, the one or more parameters including one or more of the telecom number, country code, name, address, keyword, and search depth. The plurality of heterogeneous data sources may include at least one verified partner repository and at least one search-engine results provider. The plurality of attributes may include at least two of whether the data is verified or unverified, ranking position in a search engine, timestamp of a prior validation, and consistency across the plurality of heterogeneous data sources. Assigning the weights may include classifying the data into verified data and unverified data and assigning higher weights to the verified data than to the unverified data. Generating the unified record for the telecom number that conforms to the common data model may include producing fields generated by an artificial-intelligence model in accordance with the weights assigned to the data, the fields including at least one of a title, a category, a description, a keyword, and domain information. At least one rule may be applied to the unified record, the at least one rule may include one or more of blocking a call associated with the telecom number, logging the call associated with the telecom number, updating caller identification information for the telecom number, and updating a customer relationship management database.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations. This Summary introduces a selection of concepts in a simplified form that are further described below. This Summary is not intended to identify key features or essential features of the claimed subject matter, nor is it intended to be used to determine the scope of the claimed subject matter.

### BRIEF DESCRIPTION OF DRAWINGS

FIG. 1 is an example diagrammatic view of a verification process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a verification process according to one or more example implementations of the disclosure;

FIG. 4 is an example diagrammatic view of an API call used by a verification process according to one or more example implementations of the disclosure;

FIG. 5 is an example diagrammatic view of an example distributed computing network used by a verification process according to one or more example implementations of the disclosure

FIG. 6 is an example diagrammatic view of a record and a unified record used by a verification process according to one or more example implementations of the disclosure;

FIG. 7 is an example diagrammatic view of unified records displayed by a verification process according to one or more example implementations of the disclosure; and

FIG. 8 is an example diagrammatic view of unified record rules displayed by a verification process according to one or more example implementations of the disclosure.

Like reference symbols in the various drawings may indicate like elements.

### DESCRIPTION

### System Overview

Today, there is no known reliable way to obtain accurate, real-time information about the identity or ownership of a telecom number. Businesses and consumers must rely on static databases, outdated Caller Name (CNAM) lookups, or expensive data warehouses purchased in bulk. These sources are often incomplete, inconsistent, or already stale by the time they are used. For example, one carrier may return “unknown,” another a business name, and another a personal name for the exact same number, with no unified model. Smaller companies are effectively excluded because there is no affordable “per-lookup” option—only costly bulk database subscriptions. Moreover, none of the existing solutions provide real-time insights, verification scoring, or AI-based categorization. As a result, enterprises, carriers, and end-users are left without a trustworthy or scalable way to verify telecom numbers, protect against fraud, or enrich customer data in real time.

Therefore, as will be discussed in greater detail below, the present disclosure introduce a real-time telecom verification process that unifies disparate data sources into a single, accurate record, enhanced by weighted scoring and AI summarization. By leveraging API connectivity, secure token authentication, live data queries, and a common data model, the system provides a reliable “single source of truth” for telecom number information. The present disclosure solves the above-described example problems by delivering accurate, carrier-agnostic data in real time and making it affordable and accessible on a per-lookup basis. In other words, by combining real-time API access, multi-source verification, AI-based summarization, and a unified common data model, the present disclosure transforms telecom number verification from an outdated, fragmented, and costly process into a real-time, accurate, carrier-agnostic, and affordable system. This creates a single source of truth for telecom identification and analytics, solving long-standing problems in fraud prevention, caller verification, and customer relationship management (CRM) enrichment.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module,” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tags, labels, or the like; by training on a training data set of human interactions (e.g., human interactions with software interfaces or hardware systems); by training on a training data set of outcomes; by training on an AI-generated training dataset (e.g., where a full training dataset is generated by AI from a seed training dataset); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labeled input data), unsupervised learning, and reinforcement learning. In various embodiments, a machine-learning model may be pre-trained by their operator or by a third party. Problem domains include nearly any situation where structured data can be collected and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training dataset for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer-usable or computer-readable medium (or media) may be utilized. The computer-readable medium may be a computer-readable signal medium or a computer-readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, an Ultra HD Blu-ray disc, a static random access memory (SRAM), dynamic RAM (DRAM), synchronous DRAM (SDRAM), synchronous graphics RAM (SGRAM), video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer-readable signal medium may include a propagated data signal with computer-readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer-readable program code may be transmitted using any appropriate medium, including but not limited to the internet, wireline, optical fiber cable, RF, etc. In some implementations, a computer-readable signal medium may be any computer-readable medium that is not a computer-readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine-dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java^{®}, Smalltalk, C++, or the like. Java^{®} and all Java^{®}-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a network, such as a cellular network, local area network (LAN), a wide area network (WAN), a body area network (BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application-specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer-readable program instructions to personalize the electronic circuitry in order to perform aspects of the present disclosure. Configurable or fixed-functionality logic may be implemented with complementary metal oxide semiconductor (CMOS) logic circuits, transistor-transistor logic (TTL) circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision, and machine learning applications, including through parallel processing techniques. In one or more examples, the AI accelerator may include hardware logic or devices such as a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods, and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general-purpose computer, special-purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different to indicate more constituent signal paths, have a number label to indicate a number of constituent signal paths, and/or have arrows at one or more ends to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data-processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data-processing apparatus to cause a series of operational steps to be performed (not necessarily in a particular order) on the computer or other programmable apparatus to produce a computer-implemented process such that the instructions which execute on the computer or other programmable apparatus provide steps for implementing the functions/acts (not necessarily in a particular order) specified in the flowchart and/or block diagram block or blocks or combinations thereof.

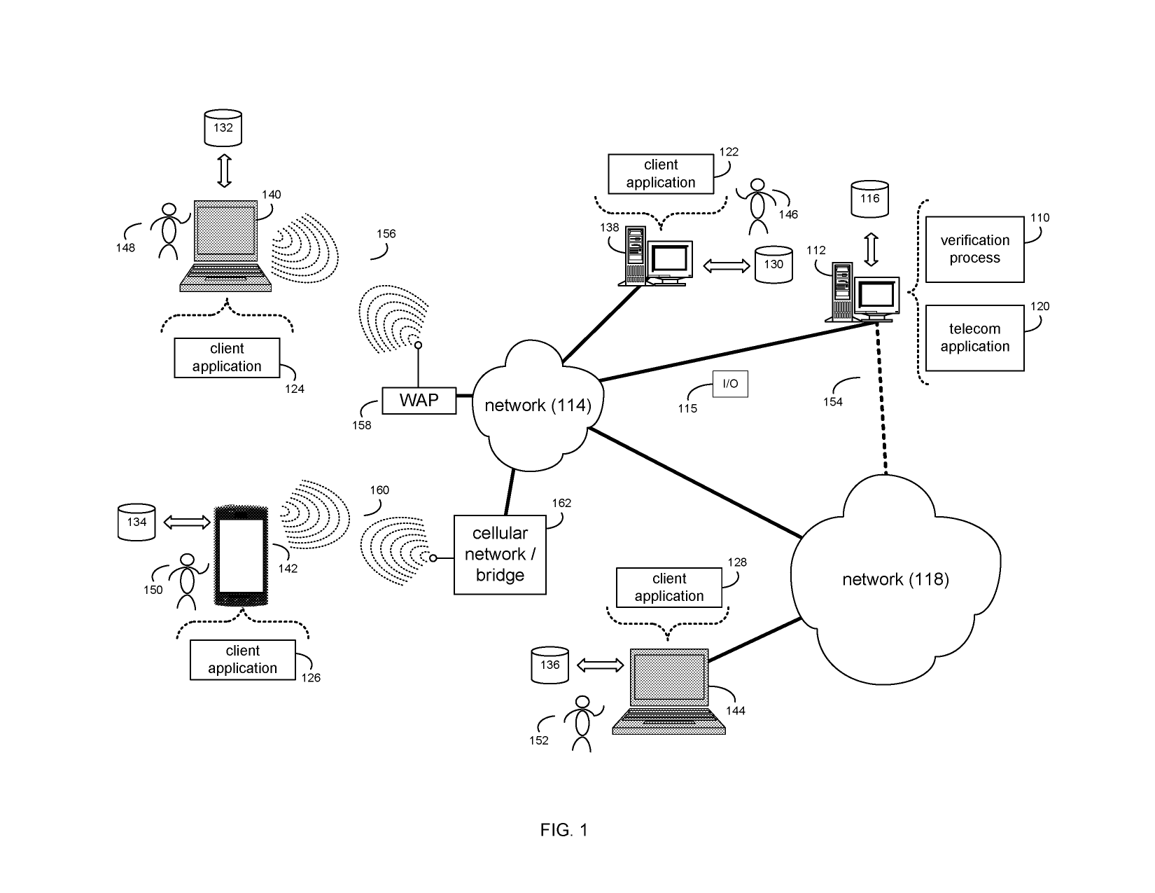

Referring now to the example implementation of FIG. 1, there is shown verification process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, a portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both.)

In some implementations, as will be discussed below in greater detail, a verification process, such as verification process 110 of FIG. 1, may receive, by a first computing device, a request identifying a telecom number from a second computing device. It may be determined that a record associated with the telecom number exists in a datastore and that the record is stale. Data associated with the telecom number may be retrieved from a plurality of heterogeneous data sources. Weights may be assigned to the data based upon, at least in part, a plurality of attributes. A unified record for the telecom number may be generated that conforms to a common data model. The unified record may be provided to the second computing device in response to the request.

In some implementations, the instruction sets and subroutines of verification process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase telecommunications network facility, as used herein, may refer to a facility configured to transmit and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above-noted relational database. In some implementations, the data store may also be a custom database, such as, for example, a flat file database or an XML database. In some implementations, any other form(s) of a data storage structure and/or organization may also be used. In some implementations, verification process 110 may be a component of the data store, a standalone application that interfaces with the above-noted data store and/or an applet/application that is accessed via client applications 122, 124, 126, 128. In some implementations, the above-noted data store may be, in whole or in part, distributed in a cloud computing topology. In this way, computer 112 and storage device 116 may refer to multiple devices, which may also be distributed throughout the network.

In some implementations, computer 112 may execute a telecom application (e.g., telecom application 120), examples of which may include, but are not limited to, e.g., a customer relationship management application, a caller name (CNAM) lookup application, an automatic speech recognition (ASR) application (e.g., speech recognition application 120), examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a navigation application, a multimedia application, a connectivity application, a voice control application, a climate control application, a smartphone integration application, a touchscreen interface application, an internet and “apps” application, a rear-seat entertainment application, or other application that allows for combining information and/or entertainment with optional screens and/or audio for such things as navigation, multimedia, connectivity, voice control, smartphone integration, touchscreen interface, internet and apps, rear-seat entertainment, etc., a virtual reality (VR) application, an extended reality (XR) application also known as mixed reality (MR), an augmented reality (AR) application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for information lookup, verification, and analytics of communication information. In some implementations, verification process 110 and/or telecom application 120 may be accessed via one or more of client applications 122, 124, 126, 128. In some implementations, verification process 110 may be a standalone application, or may be an applet/application/script/extension that may interact with and/or be executed within telecom application 120, a component of telecom application 120, and/or one or more of client applications 122, 124, 126, 128. In some implementations, telecom application 120 may be a standalone application, or may be an applet/application/script/extension that may interact with and/or be executed within verification process 110, a component of verification process 110, and/or one or more of client applications 122, 124, 126, 128. In some implementations, one or more of client applications 122, 124, 126, 128 may be a standalone application or may be an applet/application/script/extension that may interact with and/or be executed within and/or be a component of verification process 110 and/or telecom application 120. Examples of client applications 122, 124, 126, 128 may include, but are not limited to, e.g., a VR application, XR or MR application, an AR application, a customer relationship management application, a caller name (CNAM) lookup application, an automatic speech recognition (ASR) application (e.g., speech recognition application 120), examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a navigation application, a multimedia application, a connectivity application, a voice control application, a climate control application, a smartphone integration application, a touchscreen interface application, an internet and “apps” application, a rear-seat entertainment application, or other application that allows for combining information and/or entertainment with optional screens and/or audio for such things as navigation, multimedia, connectivity, voice control, smartphone integration, touchscreen interface, internet and apps, rear-seat entertainment, etc., a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for information lookup, verification, and analytics of communication information, a chatbot application, a virtual assistant application, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to client electronic devices 138, 140, 142, 144, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a vehicle’s electronic control unit (ECU) (e.g., client electronic device 140, which may encompass some or all of the electronic controls (e.g., microprocessor-controlled units) in a vehicle, managing a wide array of functions, from engine operation and fuel efficiency to handling braking systems (ABS), airbag deployment, infotainment systems, transmission systems, climate control, fuel cell operation, radiator systems, etc.), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smartphones, tablet computers, smart televisions, wearables such as watches, headsets, or glasses with a heads-up display (HUD) capable of executing a virtual reality (VR) application, an extended reality (XR) application also known as mixed reality (MR), and/or an augmented reality (AR) application, health monitoring device, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android^{TM}, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of verification process 110 (and vice versa). Accordingly, in some implementations, verification process 110 may be a purely server-side application, a purely client-side application, or a hybrid server-side / client-side application that is cooperatively executed by one or more of client applications 122, 124, 126, 128 and/or verification process 110.

In some implementations, one or more of client applications 122, 124, 126, 128 may be configured to effectuate some or all of the functionality of telecom application 120 (and vice versa). Accordingly, in some implementations, telecom application 120 may be a purely server-side application, a purely client-side application, or a hybrid server-side / client-side application that is cooperatively executed by one or more of client applications 122, 124, 126, 128 and/or telecom application 120. As one or more of client applications 122, 124, 126, 128, verification process 110, and telecom application 120, taken singly or in any combination, may effectuate some or all of the same functionality, any description of effectuating such functionality via one or more of client applications 122, 124, 126, 128, verification process 110, telecom application 120, or combination thereof, and any described interaction(s) between one or more of client applications 122, 124, 126, 128, verification process 110, telecom application 120, or combination thereof to effectuate such functionality, should be taken as an example only and not to limit the scope of the disclosure.

In some implementations, one or more of users 146, 148, 150, 152 may access computer 112 and verification process 110 (e.g., using one or more of client electronic devices 138, 140, 142, 144) directly through network 114 or through network 118. Further, computer 112 may be connected to network 114 through network 118, as illustrated with phantom link line 154. Verification process 110 may include one or more user interfaces, such as browsers and textual or graphical user interfaces, through which users 146, 148, 150, 152 may access verification process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth^{TM} (including Bluetooth^{TM} Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. Bluetooth^{TM} (including Bluetooth^{TM} Low Energy) is a telecommunications industry specification that allows, e.g., mobile phones, computers, smartphones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker (e.g., in a handset of a client electronic device). Such sound may include sound from voice telephone calls, may include recorded sound (e.g., voice messages, music files, etc.) and may also include sound generated by applications operating on the client electronic devices.

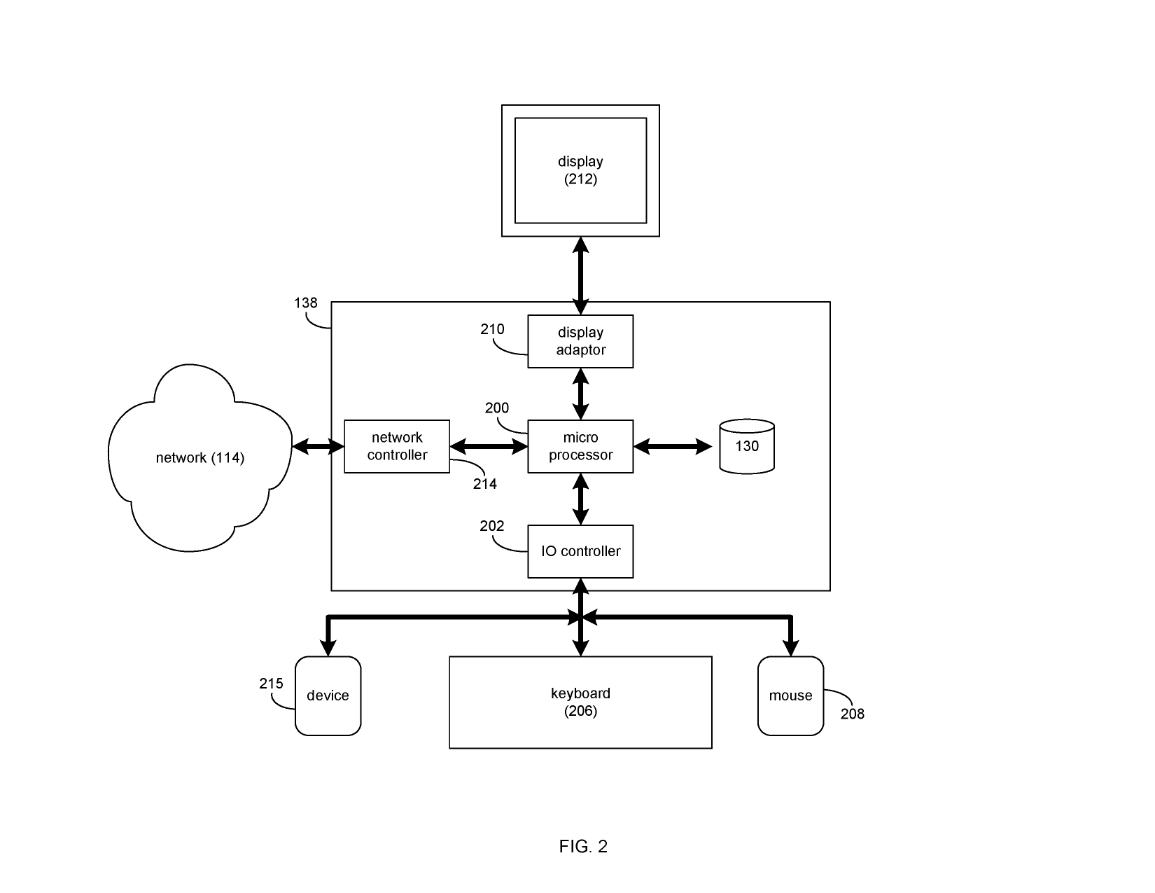

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, verification process 110 may be substituted for client electronic device 138 (in whole or in part) within FIG. 2, examples of which may include but are not limited to computer 112 and/or one or more of client electronic devices 138, 140, 142, 144.

In some implementations, client electronic device 138 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

### The Verification Process

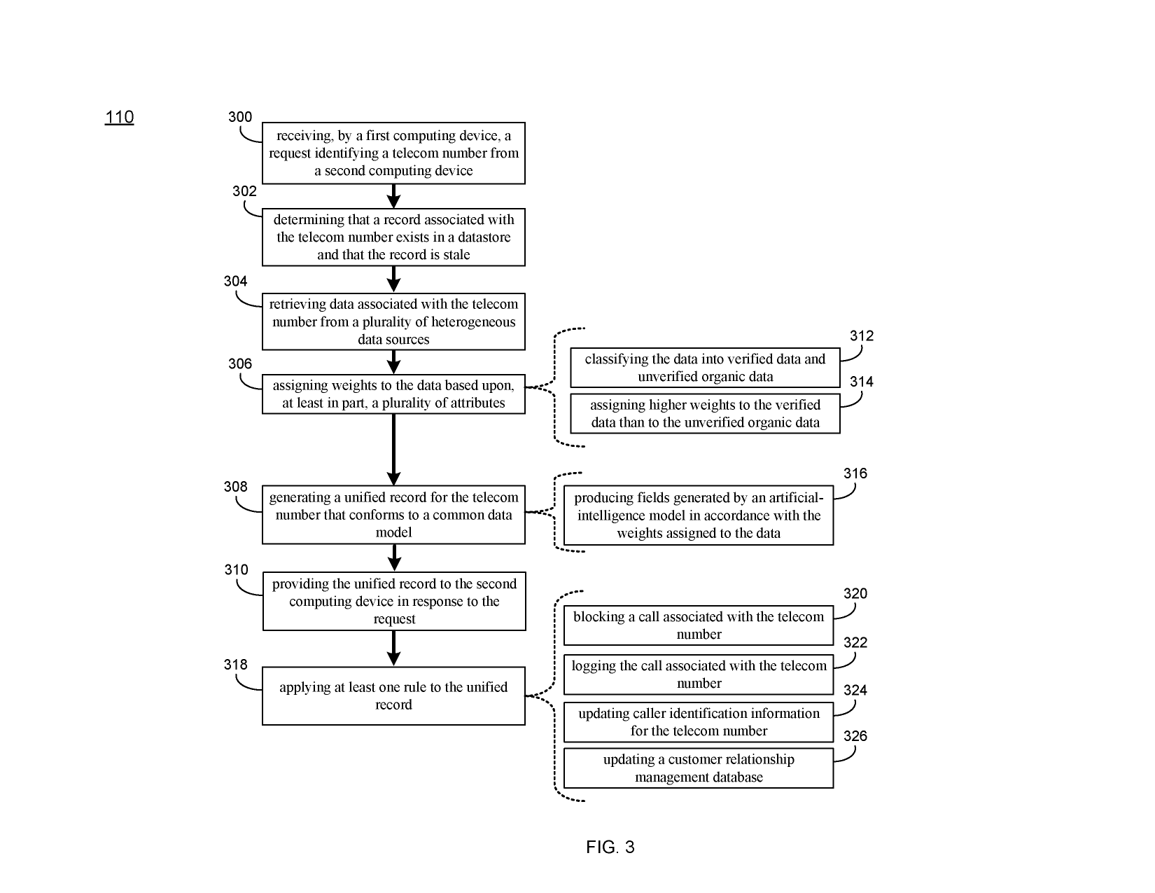

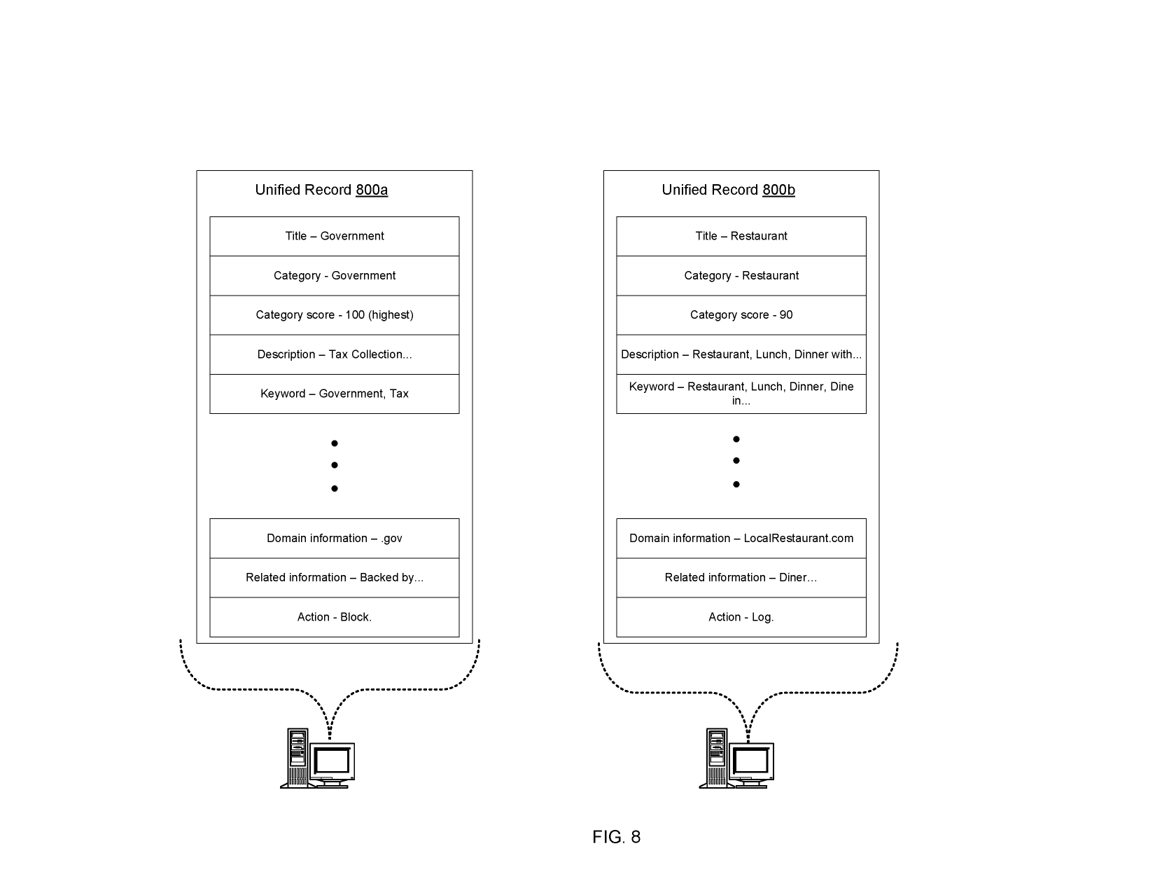

As discussed above and referring also at least to the example implementations of FIGS. 3-8, verification process 110 may receive 300, by a first computing device, a request identifying a telecom number from a second computing device. Verification process 110 may determine 302 that a record associated with the telecom number exists in a datastore and that the record is stale. Verification process 110 may retrieve 304 data associated with the telecom number from a plurality of heterogeneous data sources. Verification process 110 may assign 306 weights to the data based upon, at least in part, a plurality of attributes. Verification process 110 may generate 308 a unified record for the telecom number that conforms to a common data model. Verification process 110 may provide 310 the unified record to the second computing device in response to the request.

In some implementations, verification process 110 may receive 300, by a first computing device (e.g., computing device 112), a request (e.g., I/O 115) identifying a telecom number from a second computing device (e.g., client electronic device 138). For instance, assume for example purposes only that a customer application wants to learn who might be behind a telecom number before placing or accepting a call. In the example, verification process 110 (e.g., via client electronic devices 138) may send a request (e.g., I/O 115) that includes various attributes (discussed in greater detail below) that name the number and any needed context, which may be received by computer 112 to begin the lookup. As will be discussed in greater detail below, this step is about getting a clean, authenticated request into the system so later steps can build a unified record that follows a common data model for phone identity.

For example, in some implementations, a stateless web service of verification process 110 runs on a front-end tier and exposes a versioned REST-style endpoint that accepts JSON payloads containing the telecom number and optional fields. The front-end terminates transport layer security (TLS), validates a compact bearer token, and applies basic schema checks before persisting the request as an envelope in a durable queue. Each envelope may include a normalized number, a tenant identifier, a correlation identifier, and a request timestamp. Verification process 110 in the processing tier reads from the queue and places a short-lived lock keyed by the number and tenant to prevent duplicate work during bursts. The I/O path is instrumented with latency and throughput counters so that autoscaling rules can add workers during spikes. The API and queue may isolate external traffic from downstream processing, which stabilizes response times and prevents the system from being overwhelmed by sudden demand.

In some implementations, instead of a REST interface, the first computing device offers a gRPC service that streams inbound requests from the client device over a single long-lived encrypted channel. The client batches small requests into frames and the server uses flow control windows to throttle the stream if downstream capacity is briefly saturated. The service deserializes protobuf messages directly into an internal request object that includes the number, tenant context, and desired freshness window, then writes the object into a ring buffer backed by shared memory. A dispatcher thread of verification process 110 pulls tasks from the buffer and assigns them to worker pools sized by observed service time. This enables reduced per-request overhead and lower latency for high-volume customers due to fewer handshakes and efficient binary framing.

As another example, in some implementations, the client device publishes a request message to a multi-tenant topic on a managed message bus. The first computing device subscribes with an idempotent consumer that computes a hash from the tenant identifier, normalized number, and a nonce to detect immediate replays. Valid messages are written into a persistent log and acknowledged after a lightweight policy screen checks basic quotas and authentication claims. Any malformed or unauthorized messages are routed to a dead-letter stream for later review without blocking healthy traffic.

As yet another example, a network of edge proxies sits close to client devices and terminates incoming requests with mutual certificate validation. Each proxy applies admission control using per-tenant rate limits and caches recent authorization decisions for a short interval to minimize calls to the central identity service. Accepted requests are tagged with geo and proximity hints and forwarded over private links to the nearest regional processing cluster. If a region is degraded, the proxy fails over to the next best cluster based on current health metrics. This reduces end-to-end latency for users in diverse locations and improved resilience through regional failover without changing client behavior.

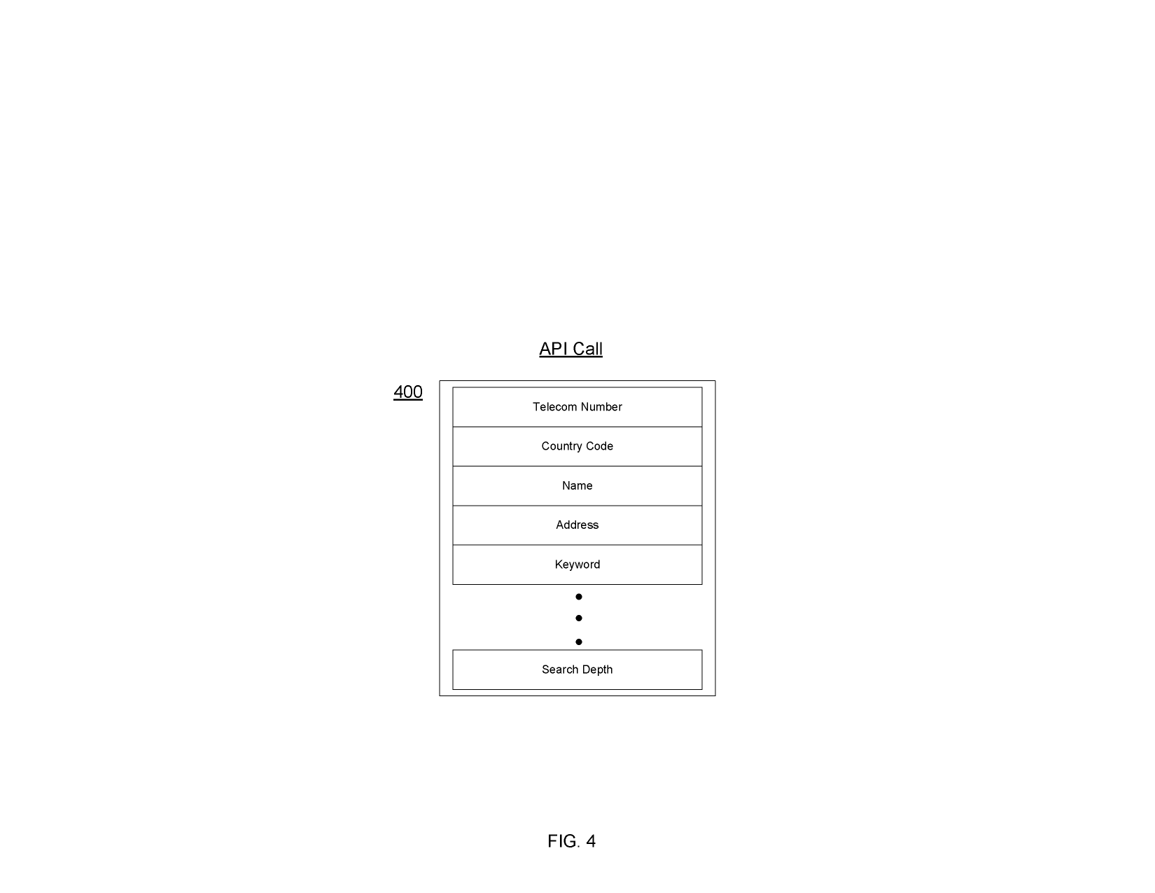

In some implementations, the request may be received as an authenticated API call including one or more parameters, the one or more parameters including one or more of the telecom number, country code, name, address, keyword, and search depth. For instance, when sending a request to look up a telecom number, verification process 110 can receive more than just the raw digits. As shown in the example implementation of FIG. 4, API call 400 includes parameters such as telecom number (e.g., the primary identifier, such as the full phone number a caller dials, receives, or wishes to look up), country code (e.g., indicates which national numbering plan applies, which avoids confusion between numbers that may look similar but belong to different regions), a name (e.g., provided when the user already suspects who the number belongs to, so verification process 110 can verify whether the results align with that expectation), an address (e.g., address to help verification process 110 confirm whether the number is tied to a physical business location or a residential listing or neither), a keyword (e.g., a descriptive tag, such as “bank” or “restaurant,” which helps filter or prioritize matching results), and search depth (e.g., defining how extensively verification process 110 should probe external sources, with a shallow search returning quick but broad results, while a deeper search involves more data sources and longer processing to gather richer information), etc. By receiving these parameters in a single authenticated API call, verification process 110 is better able to generate a precise, unified record tailored to the customer’s needs.

For example, in some implementations, verification process 110 may expose the service as a RESTful API endpoint that accepts HTTPS POST requests with a JSON payload. The payload might contain fields like “telecomNumber,” “countryCode,” “name,” “address,” “keyword,” and “searchDepth.” verification process 110 validates the request using an authentication token included in the HTTP headers and parses the JSON into an internal request object. Once parsed, the request object is normalized into a standard form, such as ensuring the telecom number is in E.164 international format and trimming or encoding text fields for consistency. The API gateway of verification process 110 also enforces rules, such as maximum search depth allowed per account or length limits on keyword fields, before passing the request to the core lookup process. This design makes it simple for customers to integrate, while the API gateway enforces uniform security and validation regardless of customer implementation.

In another implementation, the request is sent through a gRPC service using a protobuf schema. The schema explicitly defines each parameter: the telecom number as a required string, the country code as an integer, and the name, address, keyword, and search depth as optional fields. Because protobuf is strongly typed, the server can reject malformed or out-of-range parameters early, ensuring that only well-formed requests reach the processing layer. Authentication may be carried out by transmitting a signed credential in gRPC metadata.

In some implementations, verification process 110 allows clients to shape their own queries through a GraphQL endpoint. The client specifies which parameters to supply and which fields to retrieve in the response. For instance, a client could provide only the telecom number and country code if they want minimal validation, or also provide keywords and address if they are searching for a specific business listing. The GraphQL engine of verification process 110 maps these parameters into the internal request object and enforces authentication using, e.g., OAuth tokens. This approach offers flexibility, in that different customers can tailor requests to their own workflows, reducing unnecessary data transfer while still ensuring that each request is authenticated and validated.

In a more asynchronous design, the request is sent as a message to a queue or topic on a message broker of verification process 110. The telecom number is included in the message body, while the other parameters, such as country code, name, or search depth, are expressed as message attributes. A subscribing service of verification process 110 validates the message headers, authenticates the sender, and converts the message into the internal request object before initiating a lookup. This design is useful for bulk or batched lookups, where many requests arrive at once and are better processed asynchronously.

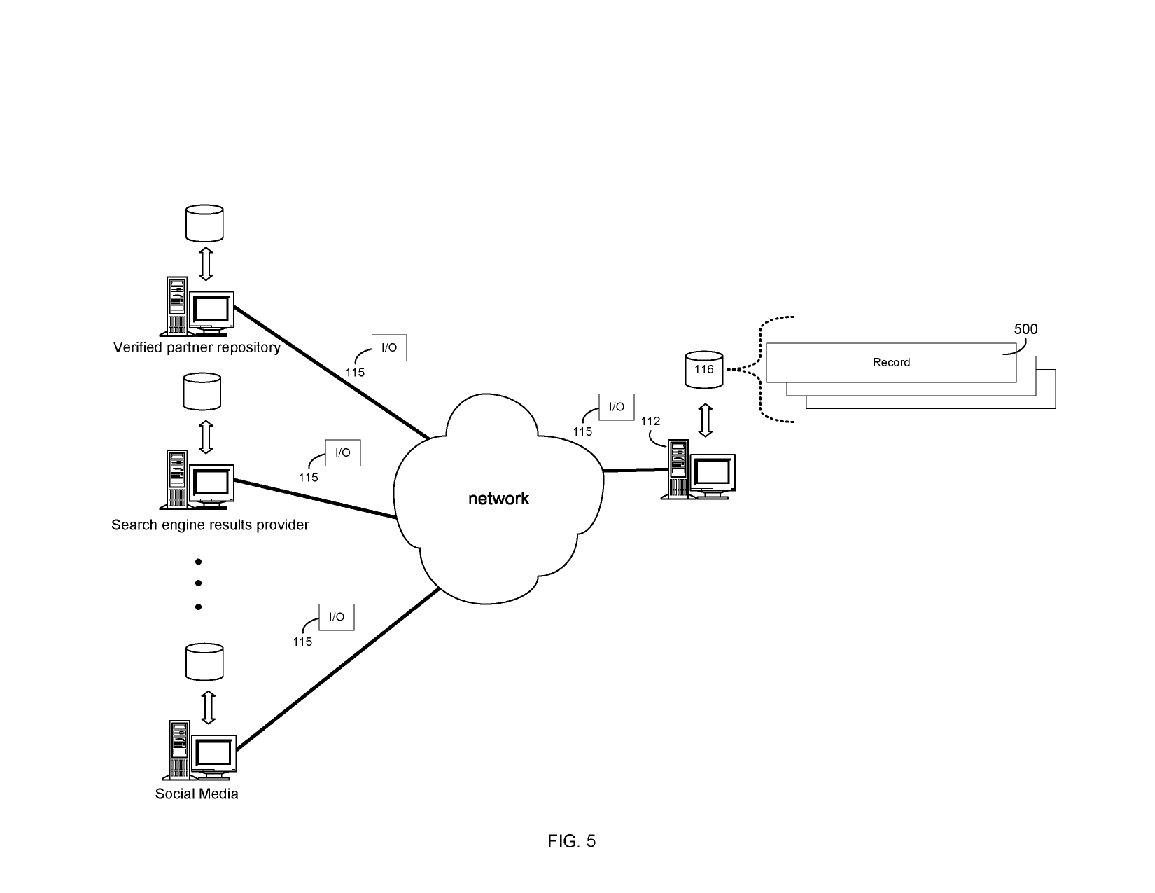

In some implementations, verification process 110 may determine 302 that a record associated with the telecom number exists in a datastore and that the record is stale. For instance, continuing with the example where verification process 110 receives a request containing a telecom number and optional parameters, verification process 110 checks whether it already has information about that number stored locally or remotely in a datastore. This stored information may generally be referred to as a record (e.g., record 500 in FIG. 5), and it might include prior lookups, associated names, or categories from earlier queries. Verification process 110 may also check whether that record is still considered “fresh,” meaning that the data falls within a predefined time window and can still be trusted as current. If the record is too old, or “stale,” it may no longer reflect the real-world state of the telecom number. For example, a number that once belonged to a business may now have been reassigned to a different owner, so relying on an outdated record could lead to errors. Determining staleness ensures that the system balances efficiency, using existing records when valid, with accuracy by refreshing outdated information when needed.

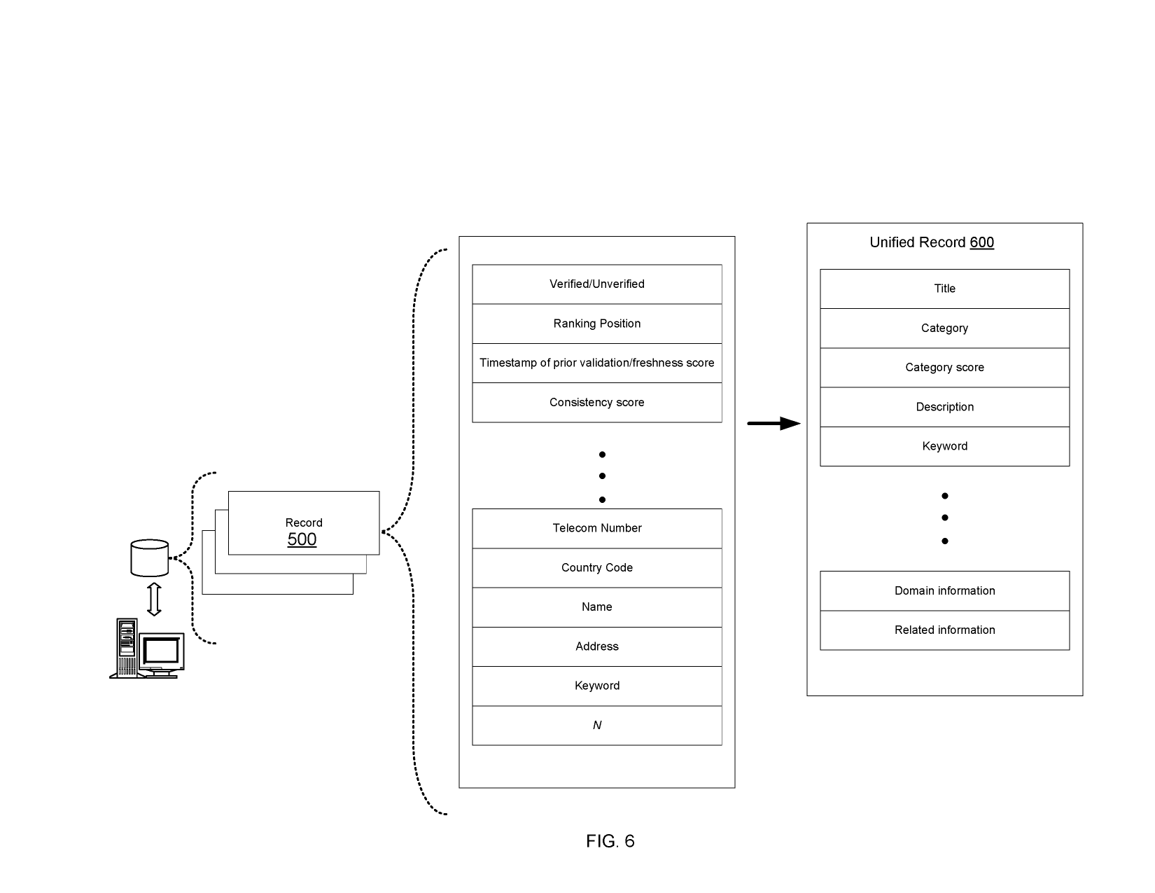

For example, in some implementations, and as shown in FIG. 6, verification process 110 stores each record in a relational datastore. As will be discussed in greater detail below, fields for the record may include the telecom number, country code, name, address, keyword, whether the data is verified or unverified, ranking position, timestamp of prior validation, a constituency score, etc. When a request is received, verification process 110 queries the datastore for the number and compares the timestamp against the configured freshness window (for example, 24 hours). If the record exists and falls within the freshness window, it is returned, but if the timestamp is older, the record is marked stale, and verification process 110 proceeds to retrieve fresh data.

In some implementations, verification process 110 uses a distributed caching layer in front of the main datastore. Each record may be inserted into the cache with an explicit time-to-live (TTL) that matches the freshness policy. When a request arrives, verification process 110 first checks the cache, where if the record is present and not expired, it is considered fresh, but if expired or missing, verification process 110 checks the main datastore or external sources. This reduces load on the central database and accelerates common lookups, making the system faster and reducing database strain.

In some implementations, instead of relying solely on a timestamp, verification process 110 can determine staleness by calculating a freshness score. The score may consider factors such as how long it has been since the last update, how often the number is queried, and the type of data associated with the number. For instance, business listings may be considered stale sooner than personal numbers because businesses change ownership or contact information more frequently. A rule engine of verification process 110 applies thresholds to decide whether the record should be reused or refreshed. Thus, verification process 110 can apply different freshness standards based on context rather than a rigid time window.

In some implementations, records are invalidated not just by time but by external signals. For example, if a carrier sends a notice that a number has been ported to another provider, or if a monitoring service detects changes in related web listings, verification process 110 proactively marks the record as stale. The datastore may include a status flag alongside the record indicating whether it is valid or invalid, and this status can override the timestamp check. It will be appreciated after reading the present disclosure that if a record does not exist in the datastore, then one can be created using the same processes discussed throughout.

In some implementations, verification process 110 may retrieve 304 data associated with the telecom number from a plurality of heterogeneous data sources (e.g., at least one verified partner repository and at least one search-engine results provider). For instance, once verification process 110 determines that a stored record for a telecom number is stale, it actively gathers new information from multiple different sources. These sources are heterogeneous, meaning they are different, and in some implementations provide data in different formats, with varying levels of reliability. A verified partner repository might be a carrier database or a registry service that can confirm the official assignment of a number. A search-engine results provider can return publicly visible references to the number, such as websites, business listings, or articles. Other examples of heterogeneous data sources may include social media platforms that mention the number, domain registration records that link numbers to websites, government or regulatory filings that list official contacts, business directory services that provide industry classifications, and fraud-reporting databases that flag numbers tied to scams or spam. Pulling from this diverse mix helps ensure verification process 110 creates a record that is both comprehensive and balanced, capturing information that is authoritative as well as signals that are publicly visible but less formally verified.

For example, in some implementations, verification process 110 sets up connectors to multiple APIs offered by verified repositories, search engines, and other providers. Verification process 110 issues parallel requests, gathers results in formats such as JSON, XML, or CSV, and feeds them into a normalization pipeline. This pipeline extracts relevant fields, standardizes number formats, and tags each data item with its origin and retrieval timestamp. The pipeline then stores all items in a temporary staging area for scoring. This approach enables flexibility and extensibility, since new connectors can be added to the pipeline without redesigning the entire system, and normalization ensures that inconsistent data from heterogeneous sources can be compared directly.

In some implementations, verification process 110 employs a federated query engine that understands how to query different kinds of sources through modular adapters. Each adapter translates a standardized query into the format required by its target, whether that is a SQL database, a REST API, or a web scraping service. The engine coordinates these queries, merges the results, and enforces quotas or throttling rules per source to avoid overuse.

In some cases, verification process 110 maintains its own crawler that scans websites, directories, and social media for phone numbers. Discovered numbers are indexed along with context such as the page title, domain, and any nearby text. When a lookup is needed, verification process 110 searches its own index in addition to live queries. As such, frequently seen numbers can be matched quickly from the local index, and contextual snippets can enrich the unified record with information not available in structured databases.

In some implementations, verification process 110 subscribes to continuous data feeds from verified partners or regulatory bodies. Instead of issuing queries only when records are stale, verification process 110 ingests updates in real time whenever partners publish changes, such as number porting events or new fraud reports. Each incoming event is stored in a change log and used to refresh or invalidate existing records. This approach ensures that important changes are reflected immediately, reducing the chance that users see stale information even between scheduled lookups.

In some implementations, verification process 110 may assign 306 weights to the data based upon, at least in part, a plurality of attributes (e.g., whether the data is verified or unverified, ranking position in a search engine, timestamp of a prior validation, and consistency via a consistency score across the plurality of heterogeneous data sources). For instance, after gathering raw information about a telecom number from many different sources, verification process 110 needs to judge how much trust to place in each piece of data. This may be done by assigning a weight that reflects reliability. For example, verified data from a carrier registry may be scored higher than an unverified mention on a blog. Search engine ranking position can be a clue that certain results (i.e., higher ranked results) are more authoritative, while a timestamp of prior validation shows how recent the data is. Consistency across sources strengthens confidence, such that if multiple independent sources report the same business name for a number, that data should weigh more heavily. Other possible attributes can also be considered, such as the reputation of the data source, the geographic alignment between the number’s area code and an address, the formatting quality of the record (e.g., complete structured entry versus fragmented text), or the historical stability of the number (whether it changes owners frequently). By combining these attributes into weights, verification process 110 can push trustworthy data to the top and downplay information that is weak or contradictory.

For example, in some implementations, verification process 110 uses a rule engine where each attribute contributes to a weighted score according to fixed thresholds. For instance, verified carrier data might always add 50 points, while a consistent match across three sources adds another 30 points, and a recent timestamp adds 20 points. Search engine rank may then be converted into a score, with higher positions getting more weight. The rule engine of verification process 110 sums these contributions to generate an overall weight per data item.

In some implementations, verification process 110 may model trustworthiness as a probability distribution. Each attribute, such as verification status or consistency, contributes evidence that raises or lowers the probability that a data item is accurate. A Bayesian inference engine, for example, combines these signals into a posterior probability of correctness. Verification process 110 then normalizes probabilities into weights for ranking, enabling the model to adapt as new sources or attributes are introduced, and probability outputs provide more nuanced insight than static thresholds.

In some implementations, verification process 110 may use a machine learning model trained on historical labeled data. Training samples might include telecom numbers with known correct metadata and a variety of incorrect or outdated associations. Features fed into the model include verification flags, source reputation scores, recency values, search rank indicators, and consistency metrics. The model, which could be a gradient boosting machine or a neural network, etc. outputs a confidence score for each candidate data item. Over time, the model adapts as it learns from feedback loops, such as user corrections or confirmed fraud reports, becoming more accurate at distinguishing high-quality data from noise in complex and changing environments.

In some implementations, verification process 110 may use a generative AI model not only for summarization but also for actively participating in weighting. The model ingests the full set of candidate data, along with contextual prompts about what attributes matter most (e.g., verification, consistency, recency, geographic alignment, reputation). Verification process 110 generates weight adjustments dynamically by reasoning across the set of attributes. For example, if three unrelated sources agree on a business name but a verified partner shows an older conflicting entry, verification process 110 can rebalance the weights to favor the newer consistent set while still acknowledging the verified source. Using this approach, verification process 110 can adapt to complex data conflicts, so instead of rigid rules, verification process 110 can reason across contradictory signals and highlight why a given weight was assigned.

As noted above, when information about a telecom number is retrieved from multiple independent data sources, the results may not always align perfectly. For example, one source may indicate that the number belongs to a local bank, another source may describe it as a general financial institution, and yet another may list it under a personal name. To resolve these differences, verification process 110 can calculate a consistency score that reflects how much agreement exists across all sources, which may be stored in record 500. A high consistency score indicates strong corroboration among sources, suggesting that the information is reliable. A low consistency score highlights conflicts, signaling that the number’s ownership or categorization may be uncertain. By incorporating consistency into its weighting process, verification process 110 ensures that heavily corroborated information influences the unified record more than isolated or contradictory entries.

As one example, verification process 110 constructs attribute sets for each source, including fields such as name, category, address, or domain. For each attribute, verification process 110 counts how many sources report the same value. If most sources agree on a value, the attribute receives a higher consistency contribution. The final score can be expressed as a percentage of agreeing attributes across all fields and sources.

In some implementations, instead of requiring exact matches, verification process 110 applies similarity measures across attributes. For example, string comparison or edit-distance algorithms can score “Nashville Bank” and “Nashville Local Bank” as highly similar, even if not identical. Each attribute type can carry its own weight (e.g., name 40%, domain 30%, category 20%, address 10%). The weighted similarities are aggregated into the final consistency score.

In some implementations, each data source itself has a reliability weight based on its origin. Carrier databases or government registries may receive higher trust ratings, while blogs or unverified web entries receive lower ratings. The consistency score is then computed by measuring agreement among sources while multiplying their contributions by reliability weights. For example, agreement between two highly trusted sources counts more than agreement between two unverified mentions.

In some implementations, verification process 110 uses a generative or embedding-based AI model evaluates the entire set of retrieved records holistically. The model looks not just for textual matches but for semantic alignment, such as recognizing that “Nashville Bank Corp.” and “Nashville Local Bank” with the same domain represent the same entity. Verification process 110 outputs a consistency score along with an explanation of which attributes reinforced agreement and which created conflict.

In some implementations, assigning the weights may include classifying 312 the data into verified data and unverified data and assigning 314 higher weights to the verified data than to the unverified data. For instance, once verification process 110 has gathered raw data about a telecom number, verification process 110 separates the results into two main example categories: verified data and unverified organic data. Verified data, as discussed above, is information that comes from trusted sources, such as a telecom carrier registry, a government filing, or a validated business directory. Because these sources typically have formal processes for confirming ownership, their data is treated as more reliable. Unverified “organic” data, on the other hand, comes from less controlled places like search engine results, social media posts, or user-generated content. This kind of information may still be useful but carries a higher risk of being outdated, misleading, or even intentionally false. By classifying and then weighting these two categories differently, verification process 110 ensures that verified information strongly influences the unified record, while organic data contributes context but is less dominant. For example, if a verified carrier listing shows a number belonging to “Nashville Local Bank,” but several blogs mention it in other contexts, verification process 110 will lean toward the carrier’s version while still storing the additional references for completeness.

In some implementations, verification process 110 may first apply a binary flag to each data item: verified or unverified. Verified status is assigned if the source is on a trusted list, such as a partner registry or a certified business directory. Organic data sources are marked unverified. During scoring, verified entries are automatically given a higher baseline weight. This scheme makes it clear to downstream processes which information should dominate in conflicts.

In some implementations, instead of a strict verified/unverified split, verification process 110 can introduce multiple tiers of trust. For example, tier 1 may be carrier databases, tier 2 may be official regulatory filings, tier 3 may be reputable directories, and tier 4 may be general web mentions. Each tier is assigned progressively lower default weights. This structure still favors highly verified data but allows for more granular ranking among unverified sources.

In some implementations, verification process 110 uses a trained classifier to decide whether incoming data items should be labeled as verified or unverified. Features such as domain reputation, HTTPS certificate validity, formatting of contact details, and past reliability of the source can be fed into the model. The classifier outputs a label and a probability score, and the label determines category, while the probability can further adjust the assigned weight.

In some implementations, verification process 110 uses a generative AI model tasked with reviewing all the gathered data holistically. Instead of looking at each item in isolation, it considers the context. For example, if multiple independent organic sources align with an older verified record, the AI model of verification process 110 may downgrade confidence in the verified entry and rebalance the weights accordingly. The AI model generates an explanation alongside its classification, making the decision more transparent.

In some implementations, verification process 110 may generate 308 a unified record for the telecom number that conforms to a common data model, and in some implementations, generating the unified record for the telecom number that conforms to the common data model may include producing 316 fields generated by an artificial-intelligence model in accordance with the weights assigned to the data, the fields including at least one of a title, a category, a description, a keyword, and domain information. For instance, after collecting and weighting information from multiple sources, verification process 110 creates a unified record (e.g., unified record 600 in FIG. 6) so that every available telecom number (in the datastore) is represented in the same, predictable shape. In this context, a common data model can generally be described as a schema and vocabulary that fixes field names, datatypes, allowed values, and relationships, such as a title string, a category drawn from a controlled taxonomy, a description as short free text, one or more keywords as tags from an approved list, and domain information as a normalized URL. The significance of this unification is both operational and analytical, in that downstream systems can integrate the record without custom adapters, bulk analytics can compare records reliably, and audit processes can check conformance to the same rules every time. Verification process 110 populates the fields while honoring the previously assigned source weights, so higher confidence inputs shape the final record more than weaker or conflicting inputs.

For example, in some implementations, verification process 110 builds a structured prompt that contains the candidate data items, each with its numeric weight, provenance identifier, and attribute type labels, etc. The prompt instructs the model to choose one value per schema field, to prefer items with larger weights, and to map any free text to the common taxonomy where applicable. The model runs with constrained decoding using a function calling interface or a JSON schema constraint so that valid fields and datatypes can be emitted. Verification process 110 validates the output against the common data model, performing ontology alignment for category and keyword using a mapping table and a soft string matcher for near synonyms. If a field fails validation, a lightweight repair step re-prompts for that field with a reduced context to meet latency targets. In this implementation, the use of weight-aware prompting plus schema-constrained decoding yields consistent, standards-compliant records while preserving the model’s ability to resolve minor conflicts in language.

In some implementations, instead of a single generative call, verification process 110 includes a field router that selects specialist components per field. A multiclass classifier assigns category using a fine-tuned transformer trained on the common taxonomy and validates against allowed labels. A keyword extractor of verification process 110 uses a sequence tagging model to propose candidate tags, then a calibrator prunes tags using weight thresholds and inverse document frequency to avoid generic terms. A title resolver of verification process 110 uses a reranker over candidate titles produced by a small generator, scoring each candidate with a linear model that combines source weight, consistency score, and string quality metrics such as length and presence of disallowed tokens. A summarizer of verification process 110 produces the description from the top weighted sources with a strict token budget and a style constraint to avoid marketing adjectives. Confidence scores per field may be computed via temperature scaling on classifier logits and through dropout based uncertainty for generator outputs. This may allow decoupling fields for targeted retraining and explicit calibration, which improves traceability and reduces cross-field error propagation.

In some implementations, all candidate values are converted into vector embeddings using a domain tuned encoder. For each field, an agglomerative clusterer groups semantically similar candidates. Cluster scores are computed as the sum of member weights multiplied by pairwise cosine similarity means, which naturally lifts dense agreement and lowers isolated outliers. The top cluster provides the canonical value by selecting the medoid for discrete fields or by passing the cluster content to a small deterministic template synthesizer for the description field. Taxonomy mapping is performed by projecting candidate embeddings onto class centroids built from curated exemplars for the category vocabulary. The pipeline does not need to rely on large generative steps and may use only deterministic rules once embeddings are computed.

In some implementations, verification process 110 constructs a compact context from the highest weighted and most consistent snippets, using a retriever that enforces per source caps to prevent any one origin from dominating, and verification process 110 produces field candidates together with rationales that cite snippet identifiers. A verifier model of verification process 110 may independently score each field by checking whether the rationale aligns with the cited snippets using natural language inference, and rejects any hallucinated claims. A counterfactual check reruns the generator after withholding the strongest single source to ensure the output is not brittle, and if the field changes materially, verification process 110 reduces its confidence and either requests more data or falls back to the embedding hub.

In some implementations, the common data model is stored as a machine readable contract that includes JSON schema, a taxonomy file for category, an allowed tag list for keywords with parent child relations, and normalization rules for domain such as punycode conversion and scheme stripping. Verification process 110 enforces token budgets per field to keep latency predictable, with micro batching at the model gateway so that multiple lookups share one forward pass without cross tenant data mixing. Caching strategies include memorizing stable taxonomy mappings and short term caching of embedding vectors for repeated values. Drift monitoring compares live field distributions to training distributions and raises alerts if novel categories or unusual description patterns appear, triggering a shadow validation pass with an alternate model. Safety filters remove personally sensitive text from description field if not required by the model and reject outputs that introduce entities not present in the weighted inputs. All pipelines emit a decision record that includes selected field values, candidate sets, weights, confidence scores, rationale or cluster membership, and full conformance results against the common data model, which supports audit and later reprocessing.

In some implementations, verification process 110 may provide 310 the unified record to the second computing device in response to the request. For instance, after verification process 110 generates a unified record that conforms to the common data model, verification process 110 delivers it back to the requesting device in real time (or near real time). The second computing device, often a client system such as a business application, CRM interface, telecom dashboard, or mobile app, receives the record in a structured format that can be immediately acted upon. The record may be returned through an API response in JSON, XML, or another agreed format. Because the record is unified and consistent, the receiving device does not need to reconcile or normalize data from different sources, and instead, it simply consumes a standard set of fields such as title, category, description, keywords, and domain. The significance is operational speed and simplicity, as the requester receives a trusted “single source of truth” that can be used instantly for decision-making, fraud prevention, or customer insights.

In some implementations, verification process 110 uses a synchronous REST API call. The client device (e.g., via verification process 110) sends a request and, once the unified record is generated (or already validly exists), receives the response in a JSON object. The object follows the common data model schema, ensuring that every field is named and typed consistently. As an example advantage, this provides a straightforward integration for developers who only need to parse standard JSON (or other) fields without custom logic.

In some implementations, verification process 110 uses gRPC, where the server returns the unified record as a protobuf message. gRPC supports bidirectional streaming, so the server can send interim updates if some fields of the unified record are ready earlier than others. For example, the title and category might be returned first while the AI-generated description is finalized. This reduces latency for time-sensitive applications, as the client can act on partial data without waiting for the full record.

In some implementations, such as a bulk or high-volume scenario, verification process 110 may return an immediate acknowledgment with a request identifier, and later provide the unified record via a webhook or message queue. The client subscribes to updates and processes the unified record once verification process 110 has completed the lookup and summarization. This allows verification process 110 to handle thousands of simultaneous requests without holding open connections, while clients still receive full structured records as soon as they are ready.

In some regulated environments, the unified record may be packaged with additional metadata, such as a confidence score, the contributing sources, and the AI rationale for field selection. This package may be digitally signed and encrypted before delivery to the client device, ensuring integrity and confidentiality. The client can verify the signature before storing or displaying the record, enabling trust and compliance, particularly when records are used in fraud detection or customer verification where auditability is mandatory.

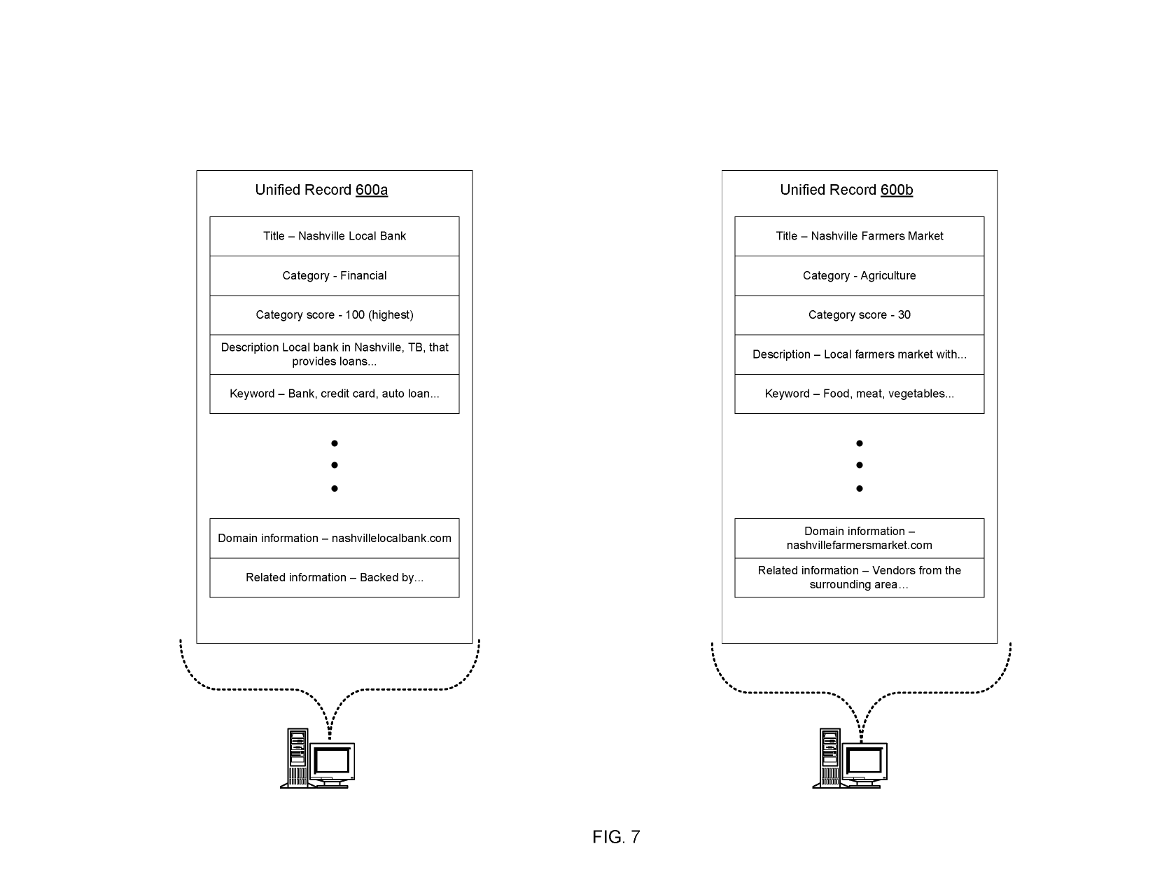

As shown in FIG. 7, two example unified records 600a and 600b for display are shown. In the example for unified record 600a, assume that a business verification request is received. In the example, a customer support platform receives a call from 123-456-7890. It sends the number and a keyword “bank” in its API request, where verification process 110 determines that the carrier record and multiple web listings align on “Nashville Local Bank.” verification process 110 returns the unified record with title “Nashville Local Bank,” category “Financial,” description “Local bank in Nashville, TN, offering loans and credit services,” keywords “Bank, Credit Card, Loan,” and domain “nashvillelocalbank.com.” As shown in FIG. 7, the client system displays this information to the user, who can greet the caller by name with confidence. A similar example is shown in unified record 600b.

In some implementations, verification process 110 may apply 318 at least one rule to the unified record, wherein applying at least one rule to the unified record may include blocking 320 a call associated with the telecom number. For instance, once the unified record has been created, verification process 110 can go beyond simply returning information and can enforce rules on how that information is used. One such rule is blocking calls associated with certain categories of numbers. Referring to FIG. 800a, the unified record may include fields such as title, category, description, keywords, domain information, related information, and even recommended actions. In this example, the title and category identify the number as government-related, the category score indicates high confidence, and the description and keywords provide context like “Tax Collection.” The record also shows domain information ending in “.gov” and supporting related information. At the bottom, the unified record specifies the Action: Block. This means that when a call is made to or from the number, the telecom system or private branch exchange (PBX) can use the unified record to automatically prevent the call from completing.

For example, in some implementations the unified record is passed into a policy engine of verification process 110 that compares its fields against predefined rules. A rule may state: if category (or subcategory) equals “Government” and keywords include “Tax,” then action = block. The policy engine runs in real time, intercepting call setup requests and enforcing the action before the call is connected.

In some implementations, instead of matching only against categories, verification process 110 uses weighted scores. For instance, a rule may say: if category score ≥ 90 and the category is in the restricted list, block the call. This allows rules to scale across different categories while relying on the AI-generated confidence score. In some implementations, an AI model of verification process 110 reads the unified record holistically and determines whether to apply a blocking action. The model considers not just category and score but also related information and domain context. For example, if multiple sources indicate fraud complaints tied to the number, the AI may override a neutral rule to block calls anyway.

In some implementations, the unified record and associated rules are pushed out to distributed edge devices, such as local PBX systems or mobile carriers’ routing equipment. When a call attempt occurs, the device queries the local rule cache and blocks the call immediately if a matching rule exists.

In some implementations, applying at least one rule to the unified record may include logging 322 the call associated with the telecom number. For instance, in some cases, the unified record does not require that a call be blocked, but it may still be important to monitor or track the call for compliance, auditing, or business insight purposes. Referring to FIG. 800b, the unified record shows a number categorized as a “Restaurant,” with a category score of 90 and supporting information such as a description, relevant keywords like “Lunch” and “Dinner,” a domain (LocalRestaurant.com), and related details. At the bottom, the record specifies Action: Log. This means that whenever a call to or from this number occurs, the telecom system or PBX does not block the call, but instead records the event into a call log. The log may capture details such as the caller, the callee, the time, the duration, and the unified record fields that were returned. This may be particularly useful for auditing if Do Not Call lists are being honored.

For instance, in some implementations, verification process 110 routes call events, enriched with the unified record fields, into a centralized logging database. Each record contains the telecom number, time of call, employee extension, and the AI-enhanced fields such as category and keywords. This log can then be queried or exported to compliance officers or managers.

As another example, instead of storing logs only in a database, verification process 110 can stream call logs to a real-time dashboard. For example, when an employee calls the restaurant number, the log entry appears instantly on a supervisor’s dashboard with fields like “Category: Restaurant” and “Keywords: Lunch, Dinner.”

Another approach applies selective logging rules so not all calls are recorded in detail. For instance, only categories such as “Restaurant” or “Entertainment” may be logged for workplace productivity tracking, while personal calls may not be logged at all to protect privacy. The unified record’s category field is used as a filter to determine whether logging applies.

In some implementations, such as in distributed telecom environments, local PBX devices can log calls involving flagged categories and then forward logs to a central repository in batches. This ensures call events are captured even if network connectivity to the central server is interrupted.

In some implementations, applying at least one rule to the unified record may include updating 324 caller identification information for the telecom number, and in some implementations, applying at least one rule to the unified record may include updating 326 a customer relationship management database. For instance, beyond blocking or logging, another example use of the unified record is updating other systems so that they always have accurate information about telecom numbers. One system that benefits directly is caller identification (caller ID). If the unified record determines that a number belongs to “Nashville Local Bank,” verification process 110 can update the caller ID registry so that the correct name displays on future calls. This reduces confusion and strengthens trust between callers and recipients. Similarly, organizations can use the unified record to update their customer relationship management (CRM) database. For example, if a sales team’s CRM currently lists a number as belonging to an individual but the unified record shows it now belongs to a business, the CRM entry can be corrected automatically. The significance is that the unified record acts not only as a momentary lookup but also as a continuous source of truth that keeps connected systems, such as telecom networks, enterprise apps, and CRMs, accurate and current.

For example, in some implementations, verification process 110 integrates the unified record service with a caller ID update API offered by carriers or third-party registries. When the unified record is generated, its “title” and “category” fields are mapped into the caller ID database fields. For instance, “Title: Nashville Local Bank” is published as the caller ID display name for the associated number. Updates are timestamped and include confidence scores so carriers can decide whether to immediately apply or hold changes for review.

In some implementations, verification process 110 provides connectors that synchronize unified record fields into popular CRM systems. When a call log is attached to a customer account, verification process 110 checks the unified record, and if new details like domain, keywords, or category differ from existing CRM entries, the CRM is automatically updated. For example, if the CRM listed the number under “Unknown” but the unified record provides “Local Restaurant,” the CRM updates its entry with the business name, category “Restaurant,” and associated domain.

In some implementations, a rules engine of verification process 110 determines whether to update caller ID, CRM, or both. For example, verified government or financial numbers may automatically update caller ID databases, while unverified organic numbers may only update CRM entries for internal use. Rules can also prevent overwriting CRM fields unless confidence scores exceed a threshold.

In some implementations, verification process 110 may use an AI model to interpret unified record fields and synthesizes richer CRM notes. For example, from “Title: Nashville Local Bank” and “Keywords: Loan, Credit, Auto,” verification process 110 might generate a CRM description: “Regional financial institution offering consumer lending services.” This enrichment helps sales or support staff immediately understand the nature of the entity without manual research. This enables higher productivity, as CRM users work with ready-made context that would otherwise require separate lookups.

The terminology used herein is for the purpose of describing particular implementations only and is not intended to be limiting of the disclosure. As used herein, the singular forms “a,” “an,” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, by a first computing device, a request identifying a telecom number from a second computing device;
determining that a record associated with the telecom number exists in a datastore and that the record is stale;
retrieving data associated with the telecom number from a plurality of heterogeneous data sources;
assigning weights to the data based upon, at least in part, a plurality of attributes;
generating a unified record for the telecom number that conforms to a common data model; and
providing the unified record to the second computing device in response to the request.

2. The computer-implemented method of claim 1, wherein the request is received as an authenticated API call including one or more parameters, the one or more parameters including one or more of the telecom number, country code, name, address, keyword, and search depth.

3. The computer-implemented method of claim 1, wherein the plurality of heterogeneous data sources includes at least one verified partner repository and at least one search-engine results provider.

4. The computer-implemented method of claim 1, wherein the plurality of attributes include at least two of whether the data is verified or unverified, ranking position in a search engine, timestamp of a prior validation, and consistency across the plurality of heterogeneous data sources.

5. The computer-implemented method of claim 1, wherein assigning the weights includes:
classifying the data into verified data and unverified data; and
assigning higher weights to the verified data than to the unverified data.

6. The computer-implemented method of claim 1, wherein generating the unified record for the telecom number that conforms to the common data model includes producing fields generated by an artificial-intelligence model in accordance with the weights assigned to the data, the fields including at least one of a title, a category, a description, a keyword, and domain information.

7. The computer-implemented method of claim 1 further comprising:
applying at least one rule to the unified record, the at least one rule including one or more of:
blocking a call associated with the telecom number;
logging the call associated with the telecom number;
updating caller identification information for the telecom number; and
updating a customer relationship management database.

8. A computing system including one or more processors and one or more memories configured to perform operations comprising:
receiving, by a first computing device, a request identifying a telecom number from a second computing device;
determining that a record associated with the telecom number exists in a datastore and that the record is stale;
retrieving data associated with the telecom number from a plurality of heterogeneous data sources;
assigning weights to the data based upon, at least in part, a plurality of attributes;
generating a unified record for the telecom number that conforms to a common data model; and
providing the unified record to the second computing device in response to the request.

9. The computing system of claim 8, wherein the request is received as an authenticated API call including one or more parameters, the one or more parameters including one or more of the telecom number, country code, name, address, keyword, and search depth.

10. The computing system of claim 8, wherein the plurality of heterogeneous data sources includes at least one verified partner repository and at least one search-engine results provider.

11. The computing system of claim 8, wherein the plurality of attributes include at least two of whether the data is verified or unverified, ranking position in a search engine, timestamp of a prior validation, and consistency across the plurality of heterogeneous data sources.

12. The computing system of claim 8, wherein assigning the weights includes:
classifying the data into verified data and unverified data; and
assigning higher weights to the verified data than to the unverified data.

13. The computing system of claim 8, wherein generating the unified record for the telecom number that conforms to the common data model includes producing fields generated by an artificial-intelligence model in accordance with the weights assigned to the data, the fields including at least one of a title, a category, a description, a keyword, and domain information.

14. The computing system of claim 8, wherein the operations further comprise:
applying at least one rule to the unified record, the at least one rule including one or more of:
blocking a call associated with the telecom number;
logging the call associated with the telecom number;
updating caller identification information for the telecom number; and
updating a customer relationship management database.

15. A computer program product residing on a computer readable storage medium having a plurality of instructions stored thereon which, when executed across one or more processors, causes at least a portion of the one or more processors to perform operations comprising:
receiving, by a first computing device, a request identifying a telecom number from a second computing device;
determining that a record associated with the telecom number exists in a datastore and that the record is stale;
retrieving data associated with the telecom number from a plurality of heterogeneous data sources;
assigning weights to the data based upon, at least in part, a plurality of attributes;
generating a unified record for the telecom number that conforms to a common data model; and
providing the unified record to the second computing device in response to the request.

16. The computer program product of claim 15, wherein the request is received as an authenticated API call including one or more parameters, the one or more parameters including one or more of the telecom number, country code, name, address, keyword, and search depth.

17. The computer program product of claim 15, wherein the plurality of heterogeneous data sources includes at least one verified partner repository and at least one search-engine results provider.

18. The computer program product of claim 15, wherein the plurality of attributes include at least two of: whether the data is verified or unverified, ranking position in a search engine, timestamp of a prior validation, and consistency across the plurality of heterogeneous data sources, and wherein assigning the weights includes:
classifying the data into verified data and unverified data; and
assigning higher weights to the verified data than to the unverified data.

19. The computer program product of claim 15, wherein generating the unified record for the telecom number that conforms to the common data model includes producing fields generated by an artificial-intelligence model in accordance with the weights assigned to the data, the fields including at least one of a title, a category, a description, a keyword, and domain information.

20. The computer program product of claim 15, wherein the operations further comprise:
applying at least one rule to the unified record, the at least one rule including one or more of:
blocking a call associated with the telecom number;
logging the call associated with the telecom number;
updating caller identification information for the telecom number; and
updating a customer relationship management database.
